(19) United States
(12) Patent Application Publication
(10) Pub. No.: US 2016/0132284 A1
(43) Pub. Date: May 12, 2016

(54) SYSTEMS AND METHODS FOR PERFORMING DISPLAY MIRRORING

(71) Applicant: QUALCOMM Incorporated, San Diego, CA (US)

(72) Inventors: Mastan Manoj Kumar Amara Venkata, San Diego, CA (US); Ramkumar Radhakrishnan, San Diego, CA (US); Tatenda Masendeke Chipeperekwa, San Diego, CA (US); Panneer Arumugam, San Diego, CA (US); Dileep Marchya, San Diego, CA (US); Nagamalleswararao Ganji, San Diego, CA (US)

(21) Appl. No.: 14/746,814

(22) Filed: Jun. 22, 2015

Related U.S. Application Data
(60) Provisional application No. 62/077,026, filed on Nov. 7, 2014.

(51) Int. Cl. G06F 3/14; G09G 5/377

(52) U.S. Cl. CPC G06F 3/1454; G09G 5/377; G09G 2370/16; G09G 2360/18

(57) ABSTRACT

A method for display mirroring is described. The method includes computing an updating region size for one or more application layers of a screen image, the updating region area regions of interest being updated on the screen image less any overlap between the regions of interest. The method also includes determining that the updating region size plus a previous frame size is less than a frame buffer size. The method further includes determining that there are sufficient resources available to combine the previous frame with the updating region. The method additionally includes generating a current frame by combining the previous frame and the updating region. The method also includes sending the current frame to a mirrored display.

### RELATED APPLICATIONS

This application is related to and claims priority from U.S. Provisional Patent Application Ser. No. 62/077,026, filed Nov. 7, 2014, for “BUS BANDWIDTH DURING MIRRORING OF CONTENT VIA WIRELESS CONNECTION.”

### TECHNICAL FIELD

The present disclosure relates generally to electronic devices. More specifically, the present disclosure relates to systems and methods for performing display mirroring.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cellular phones, smart phones, computers, televisions, etc.) display images. For example, a smart phone may display a screen image on a touchscreen.

Electronic devices may perform display mirroring with a mirrored display. As can be observed from this discussion, systems and methods that improve display mirroring may be beneficial.

### SUMMARY

A method for display mirroring is described. The method includes computing an updating region size for one or more application layers of a screen image, the updating region area regions of interest being updated on the screen image less any overlap between the regions of interest. The method also includes determining that the updating region size plus a previous frame size is less than a frame buffer size. The method further includes determining that there are sufficient resources available to combine the previous frame with the updating region. The method additionally includes generating a current frame by combining the previous frame and the updating region. The method also includes sending the current frame to a mirrored display.

The current frame may be sent to the mirrored display using an IEEE 802.11 wireless link. The current frame may be sent to the mirrored display using a universal serial bus (USB) connection or a high-definition multimedia interface (HDMI) connection.

The frame buffer may have a first format and the previous frame may have a second format. The previous frame may be converted from the first format to the second format. The first format may be an Alpha Red Green Blue (ARGB) format and the second format may be an NV12 format.

Determining that there are sufficient resources available to combine the previous frame with the updating region may include determining that a mobile display processor has sufficient hardware resources to blend the previous frame and the updating region.

The determining steps may be performed by a software driver of a mobile display processor.

An electronic device configured for display mirroring is also described. The electronic device includes a processor, memory in communication with the processor, and instructions stored in the memory. The instructions are executable by the processor to compute an updating region size for one or more application layers of a screen image, the updating region area regions of interest being updated on the screen image less any overlap between the regions of interest. The instructions are also executable to determine that the updating region size plus a previous frame size is less than a frame buffer size. The instructions are further executable to determine that there are sufficient resources available to combine the previous frame with the updating region. The instructions are additionally executable to generate a current frame by combining the previous frame and the updating region. The instructions are also executable to send the current frame to a mirrored display.

An apparatus for display mirroring is also described. The apparatus includes means for computing an updating region size for one or more application layers of a screen image, the updating region area regions of interest being updated on the screen image less any overlap between the regions of interest. The apparatus also includes means for determining that the updating region size plus a previous frame size is less than a frame buffer size. The apparatus further includes means for determining that there are sufficient resources available to combine the previous frame with the updating region. The apparatus additionally includes means for generating a current frame by combining the previous frame and the updating region. The apparatus also includes means for sending the current frame to a mirrored display.

A computer-program product for display mirroring is also described. The computer-program product includes a non-transitory computer-readable medium having instructions thereon. The instructions include code for causing an electronic device to compute an updating region size for one or more application layers of a screen image, the updating region area regions of interest being updated on the screen image less any overlap between the regions of interest. The instructions also include code for causing the electronic device to determine that the updating region size plus a previous frame size is less than a frame buffer size. The instructions further include code for causing the electronic device to determine that there are sufficient resources available to combine the previous frame with the updating region. The instructions additionally include code for causing the electronic device to generate a current frame by combining the previous frame and the updating region. The instructions also include code for causing the electronic device to send the current frame to a mirrored display.

### BRIEF DESCRIPTION OF THE DRAWINGS

FIG. 1 is a block diagram illustrating an electronic device for use in the present systems and methods;

FIG. 2 is a flow diagram illustrating a method for performing display mirroring;

FIG. 3 is a block diagram illustrating an example of a screen image according to the described systems and methods;

FIG. 4 is a flow diagram illustrating another method for performing display mirroring;

FIG. 5 is a block diagram illustrating an example electronic device that may be used to implement the techniques described in this disclosure;

FIG. 6 is a block diagram of a transmitter and receiver in a multiple-input and multiple-output (MIMO) system; and

FIG. 7 illustrates certain components that may be included within an electronic device.

### DETAILED DESCRIPTION

The detailed description set forth below in connection with the appended drawings is intended as a description of exemplary implementations of the disclosure and is not intended to represent the only implementations in which the disclosure may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the disclosure. In some instances, some devices are shown in block diagram form.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

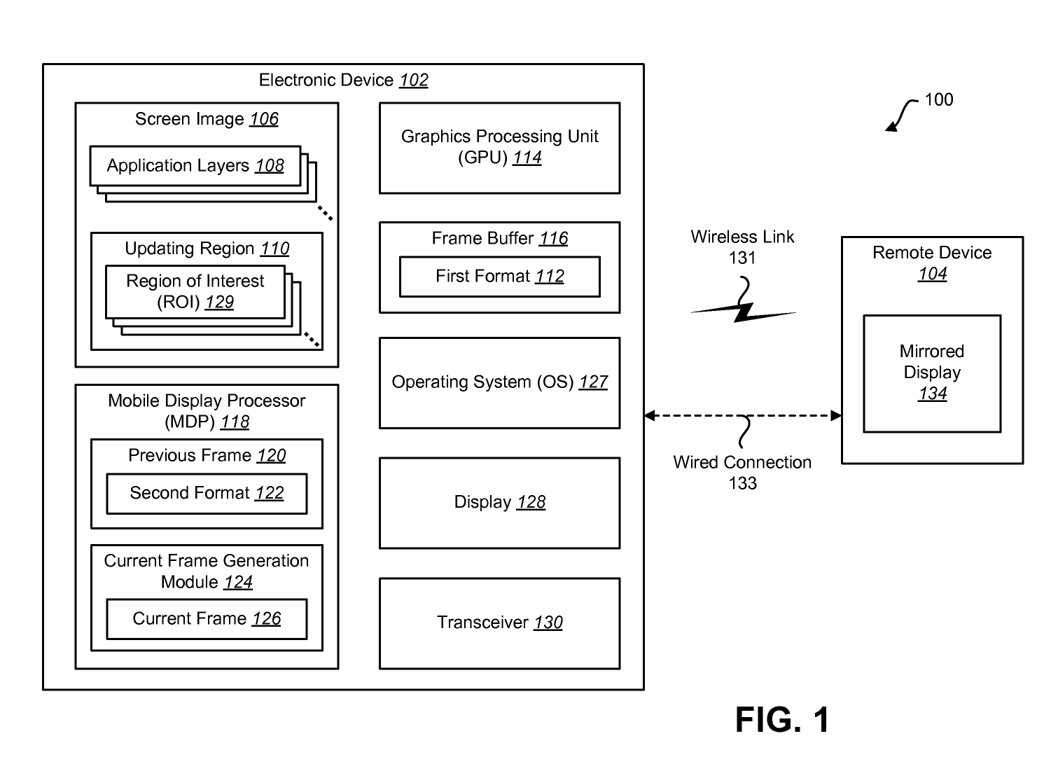

FIG. 1 is a block diagram illustrating an electronic device 102 for use in the present systems and methods. The electronic device 102 may also be referred to as a wireless communication device, mobile device, mobile station, subscriber station, client, client station, user equipment (UE), remote station, access terminal, mobile terminal, terminal, user terminal, subscriber unit, etc. Examples of electronic devices include cellular phones, smart phones, wireless modems, e-readers, tablet devices, gaming systems, etc. Some of these devices may operate in accordance with one or more industry standards.

In an implementation, communications in the communication system 100 may be achieved through transmissions over a wired or wireless link. A wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. In some configurations, the communication system 100 may utilize MIMO. A MIMO system may support time division duplex (TDD) and/or frequency division duplex (FDD) systems.

In some configurations, the communication system 100 may operate in accordance with one or more standards. Examples of these standards include Bluetooth (e.g., Institute of Electrical and Electronics Engineers (IEEE) 802.15.1), IEEE 802.11 (Wi-Fi), IEEE 802.16 (Worldwide Interoperability for Microwave Access (WiMAX), Global System for Mobile Communications (GSM), Universal Mobile Telecommunications System (UMTS), CDMA2000, Long Term Evolution (LTE), etc.

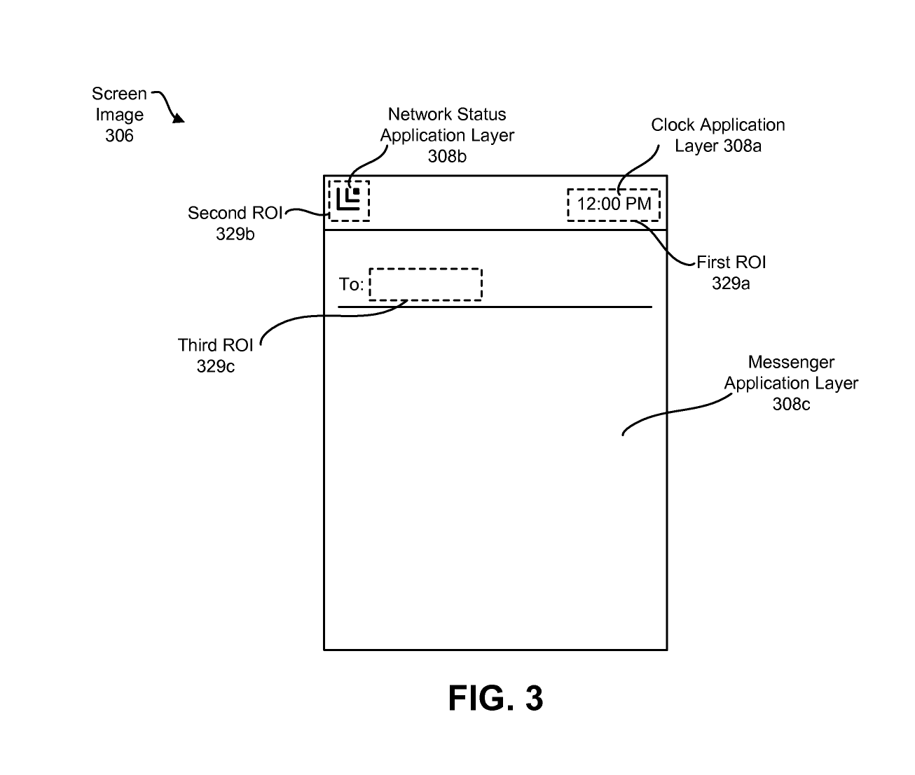

The electronic device 102 may display a screen image 106 on a display 128. The screen image 106 may be a visual representation of graphical information. In one implementation, the screen image 106 may be a graphical user interface (GUI). A screen image 106 may be composed of one or more application layers 108. Examples of applications associated with the application layers 108 may include a calendar, clock, messenger, browser, and panning application. An example of a screen image 106 is described in connection with FIG. 3.

The arrangement of the application layers 108 within the screen image 106 may be controlled by the operating system (OS) 127 of the electronic device 102. For example, the OS 127 may determine whether an application layer 108 is displayed. If an application layer 108 is displayed, the OS 127 may determine where the application layer 108 is displayed in relation to other application layers 108.

An application layer 108 may include the graphical information for a particular application or program that is displayed in the screen image 106. Examples of this graphical information may include windows, menus, icons, toolbars, status bars, navigation bars, controls (e.g., buttons, sliders, switches, activity indicators, check boxes, pickers, etc.), and displayed content (e.g., text, digital image content or video).

The one or more application layers 108 may be simultaneously displayed in the screen image 106. Therefore, there may be multiple applications, all with separate imaging requirements having to be composed at the same time or at different times. For example, the electronic device 102 may display a status bar at the top of the screen image 106. The status bar application may be associated with one application layer 108. A second application layer 108 may be associated with a clock application. The clock image may be positioned within the status bar. A third application layer 108 may be associated with a messenger application. The graphical elements of the messenger application may be positioned below the status bar.

The electronic device 102 may include a graphics processing unit (GPU) 114 and a mobile display processor (MDP) 118 for displaying the screen image 106 on a display 128. The graphics processing unit (GPU) 114 may compose the screen image 106 as a frame. As used herein, a frame is an electronically coded still image. A frame may include horizontal rows and vertical columns of pixels. The number of pixels in a frame may depend on the resolution of the display 128.

The GPU 114 may compose the screen image 106 in a frame buffer 116. The frame buffer 116 may be an area of memory for storing fragments of data during rasterization of an image on a display 128. An example of frame buffer 116 is random access memory (RAM); however, other types of memory may be used as well.

Electronic devices 102 having a display 128 for displaying video data (such as still images, a series or sequence of images that form a full motion video sequence, computer generated images, and the like) may include a frame buffer 116 to store the data (e.g., the screen image 106) before the data is presented. That is, the frame buffer 116 may store color values for each pixel in an image to be displayed. In some examples, the frame buffer 116 may store color values having 1-bit (monochrome), 4-bits, 8-bits, 16-bits (e.g., so-called High color), 24-bits (e.g., so-called True color), or more (e.g., 30-bit, 36-bit, 48-bit, or even larger bit depths). In addition, the frame buffer 116 may store alpha information that is indicative of pixel transparency.

The GPU 114 may compose the screen image 106 in the frame buffer 116 in a first format 112. The particular format in which data is stored to the frame buffer 116 may depend on a variety of factors. For example, the electronic device 102 platform (e.g., a combination of software and hardware components), may dictate the manner in which data is rendered and stored to the frame buffer 116 before being presented by the display 128.

In an example for purposes of illustration, the operating system 127 and the GPU 114 of the electronic device 102 may be responsible for rendering images and storing the images to the frame buffer 116. In this example, the operating system 127 and the GPU 114 may store data to the frame buffer 116 in the first format 112. In an implementation, the first format 112 may be an Alpha Red Green Blue (ARGB) format. One example of the ARGB format is the RGBA8888 format. In this format, eight bits are assigned to the Red channel, eight bits are assigned to the Green channel, eight bits are assigned to the Blue channel, and eight bits assigned to the Alpha channel, where the alpha information is indicative of pixel transparency. Alternatively, in another example, the operating system 127 and the GPU 114 may store data to the frame buffer 116 in a BGRA8888 format. Other formats are also possible.

A mobile display processor (MDP) 118 may retrieve the data from the frame buffer 116 and configure the display 128 to display the image represented by the rendered image data. The MDP 118 may receive pixel values for pixels of the composed screen image 106 stored in the frame buffer 116. The MDP 118 may generate a current frame 126 for display on the display 128.

The MDP 118 may convert the data stored in the frame buffer 116 from the first format 112 to a second format 122. For example, the MDP 118 may convert the data stored in the frame buffer 116 from an ARGB format to a YUV format. The YUV format is a luma-chrominance color space, where Y is the luma channel and U and V are the chrominance (chroma or color) components. Examples of the YUV format include YCbCr and Y′CbCr. In another example, pixel values can be color values in the YCoCg color space including data bits for luminance, orange chrominance, and green chrominance components.

The MDP 118 may apply compression so that fewer bits are needed to represent the color value of each pixel. The MDP 118 may similarly compress other types of pixel values such as opacity values and coordinates, as two examples. As used in this disclosure, the term “image data” may refer generally to bits of the pixel values, as stored in the frame buffer 116 and the term “compressed image data” may refer to the output of the MDP 118 after the MDP 118 compresses the image data. For example, the number of bits in the compressed image data may be less than the number of bits in the image data.

In an implementation, the MDP 118 may perform color conversion of the ARGB format frame stored in the frame buffer 116 to NV12 format. The NV12 format is an efficient YUV format. In the NV12, 12 bits may be used per pixel. Additionally, with the NV12 format, the chroma channels are downsampled by a factor of two in both the horizontal and vertical dimensions. The NV12 is a color format that may provide optimized encoder performance. Therefore, the MDP 118 may convert and downsample a frame from the first format 112 of the frame buffer 116 to the second format 122.

In some scenarios, the electronic device 102 may perform display mirroring. For display mirroring, the screen image 106 of the electronic device 102 may be displayed on a mirrored display 134 of a remote device 104. The electronic device 102 may perform display mirroring via a wired connection 133 or a wireless link 131. Examples of a wired connection 133 used for display mirroring include but are not limited to universal serial bus (USB) and high-definition multimedia interface (HDMI) connections. Examples of a wireless link 131 used for display mirroring include but are not limited to IEEE 802.11 (WiFi) and Bluetooth links.

The electronic device 102 may include a transceiver 130 for communicating with the remote device 104. The transceiver 130 may perform transmitting and receiving operations. In the case of a wired connection 133, the transceiver 130 may transmit and receive signals over a wired connection 133. In the case of a wireless link 131, the transceiver 130 may be coupled to an antenna (not shown), which may transmit signals to or receive signals from an antenna (not shown) of the remote device 104.

The remote device 104 may be an electronic device capable of receiving and displaying visual content sent by the electronic device 102. The remote device 104 may also be referred to as a sink device or a display device. In one configuration, the remote device 104 may include the mirrored display 134. For example, the remote device 104 may be a television or computer monitor that includes wired or wireless communication capabilities. In another configuration, the remote device 104 may be separate from the mirrored display 134. For example, the remote device 104 may be a USB dongle that receives the visual content from the electronic device 102 and provides this visual content to the mirrored display 134.

The remote device 104 may further comprise a mobile telephone, tablet computer, laptop computer, portable computer, personal digital assistants (PDAs), gaming device, portable media player, or other flash memory devices with communication capabilities. The remote device 104 may also include so-called “smart” phones and “smart” pads or tablets, or other types of wireless communication devices. As wired devices, for example, the display devices may comprise televisions, desktop computers, monitors, projectors, and the like, that include wired and/or wireless communication capabilities.

In one configuration, display mirroring may involve displaying the same screen image 106 on both the display 128 of the electronic device 102 and the mirrored display 134 of the remote device 104. An example of this configuration is a screen sharing mode. In another configuration, display mirroring may involve displaying the screen image 106 of the electronic device 102 only on the mirrored display 134 of the remote device 104 (and not on the display 128 of the electronic device 102). In yet another configuration, display mirroring may involve displaying different screen images 106 of the electronic device 102 on the display 128 of the electronic device 102 and the mirrored display 134 of the remote device 104. An example of this configuration may include an extended desktop mode.

In one approach to display mirroring, the GPU 114 may be used for composition of application layers 108 to the frame buffer 116 in the first format 112 (e.g., ARGB format), as described above. The MDP 118 may then generate the current frame 126 by performing color conversion to the second format 122 (e.g., NV12 format). In one approach, the color conversion may include downsampling, as described above. Upon generating the current frame 126, the electronic device 102 may send the current frame 126 to the remote device 104 for display mirroring.

In this approach, this process may be done for each frame of the screen image 106. Therefore, the entire contents the application layers 108 are composed to the frame buffer 116 by the GPU 114 and color converted by the MDP 118. This process is resource-intense. For example, the GPU 114 is required to use GPU cycles for composing a full frame buffer 116 in ARGB format. Furthermore, the MDP 118 must read a full frame buffer 116 in the ARGB format. This results in high loads on the GPU 114, the frame buffer 116, the MDP 118, buses and communication interfaces between the different components. This problem is even more severe in the case of high-definition (HD) resolutions (e.g., 1080p) and ultra-high-definition (UHD) resolutions (e.g., 4K resolution) where the image data stored in the frame buffer 116 may be large.

In many cases, only a portion of the one or more application layers 108 changes. For example, in a screen image 106, only the clock and/or text of a messenger application may change. In these cases, this approach needlessly composes each of the one or more application layers 108, which leads to inefficient use of system resources (e.g., GPU load, memory fetch, bus bandwidth, etc.).

The frame buffer 116 is a large consumer of both memory bandwidth and storage space, which can adversely impact the memory subsystem of the GPU 114. In addition, frame buffers 116 may consume a significant portion of the electronic device's 102 available power. Particularly in mobile devices with limited battery life, frame buffer 116 power consumption can present significant challenges in light of the high refresh rate, resolution, and color depth of displays 128. Thus, reducing frame buffer 116 activity helps to extend overall battery life.

According to the systems and methods described herein, the electronic device 102 may generate a current frame 126 for display mirroring by using a previous frame 120 and the portions of the screen image 106 that are changing instead of composing an entire frame buffer 116. In other words, the electronic device 102 may save and reuse a previous frame 120 and compose the part of the screen image 106 that is changing. The current frame 126 may be referred to as the Nth frame. The previous frame 120 may be referred to as the N−1th frame.

In a configuration, the MDP 118 may include a current frame generation module 124 for determining how to generate the current frame 126. The current frame generation module 124 may be implemented in software (as a driver for the MDP 118, for example) or a combination of hardware and software.

The current frame generation module 124 may compute the size of an updating region 110 for one or more of the application layers 108 of the screen image 106. The updating region 110 may be the combined area of a set of regions of interest (ROI) 129 that are being updated on the screen image 106 less any overlap between the ROI 129.

The operating system 127 may determine an ROI 129 if only a small portion of the screen image 106 changes. An ROI 129 may be provided as a set of coordinates on the screen image 106. The ROI 129 may include the area of the screen image 106 that is changing. This area may be represented as a rectangular set of pixels.

In a configuration, the size of an ROI 129 may be expressed as the number of bytes used to convey the channel information of the pixels contained in the ROI 129. For example, in the case of an ARGB format where 32 bits are used per pixel (8 bits for each of the 4 channels), if an ROI 129 includes 100 pixels, then the ROI 129 size is 3200 bits. Other units of measurement may be used to express the size of an ROI 129. For example, the size of the ROI 129 may be expressed as the area of the ROI 129.

The updating region 110 may be the summation of all of the ROIs 129 less any overlap between the ROIs 129. Therefore, the size of the updating region 110 may be the summation of the size of each ROI 129 while accounting for any overlap (e.g., union) between the ROIs 129. In other words, if two or more ROIs 129 overlap, then when determining the size of the updating region 110, only one instance of the overlapping area is included. The updating region 110 may also be referred to as a dirty region.

The updating region 110 (and the ROIs 129) may be provided in the first format 112. For example, the updating region 110 may be provided in ARGB format. The size of the updating region 110 may be determined based on the first format 112.

The current frame generation module 124 may determine whether the updating region 110 size plus the size of the previous frame 120 size is less than the frame buffer 116 size. The MDP 118 may save the previous frame 120 that was displayed. The previous frame 120 may be in the second format 122. For example, the previous frame 120 may be in the NV12 format. Because the previous frame 120 is in the second format 122, the previous frame 120 may have a smaller size than the size of the frame buffer 116, which is in the first format 112 (e.g., ARGB format).

The previous frame 120 may be stored in memory located in the MDP 118 or in another location within the electronic device 102. In one configuration, the previous frame 120 may be referred to as a writeback output.

The frame buffer 116 size may be a known quantity. The frame buffer 116 size may be based on the display 128 resolution and the first format 112. For example, if the display 128 resolution is 1600×2560 pixels, where 4 bytes (i.e., 32 bits) are used per pixel to convey the ARGB information, then the frame buffer 116 size is 16,384,000 bytes.

If the updating region 110 size plus the size of the previous frame 120 size is less than the frame buffer 116 size, then there is potential for optimization. The current frame generation module 124 may then determine whether there are sufficient resources available to combine the previous frame 120 with the updating region 110. The resources may be two or more different hardware resources used to blend the previous frame 120 with the updating region 110. These resources may be included in the MDP 118. For example, the resources may be a blending engine included in the MDP 118. The current frame generation module 124 may determine whether there are sufficient resources to blend these layers.

If the current frame generation module 124 determines that there are sufficient resources available to combine the previous frame with the updating region 110, then the MDP 118 may generate the current frame 126 by combining the previous frame 120 and the updating region 110. For example, the previous frame 120 and the updating region 110 may be fed into the MDP 118 hardware (e.g., blending engine) and combined. In other words, the previously composed (N−1th) frame 120 and the updating region 110 from the current (Nth) frame 126 may be fed into the MDP 118 hardware to compose the current (Nth) frame 126.

The MDP 118 may combine the ROIs 129 of the updating region 110 as indicated by their coordinates. The ROIs 129 may be positioned on top of the previous frame 120 according to their coordinates. Therefore, instead of composing all application layers 108, the current frame 126 may be generated from the previous frame 120 and the updating region 110.

In the case where the updating region 110 size plus the previous frame 120 size is not less than a frame buffer 116 size, then the current frame 126 may be generated from the frame buffer 116, as described above. For example, if the entire screen image 106 is changing, the summation of the updating region 110 size and the previous frame 120 size would be greater than the frame buffer 116 size. In this case, it may be more efficient to compose the current frame 126 using the frame buffer 116. Similarly, in the case where there are not sufficient resources to combine the previous frame 120 with the updating region 110, the current frame 126 may be generated from the frame buffer 116.

Upon generating the current frame 126, the MDP 118 may cause the current frame 126 to be displayed on the display 128. For example, the MDP 118 may convert the digital values of the current frame 126 into an analog signal consumable by the display 128.

The electronic device 102 may also send the current frame 126 to the mirrored display 134. For example, the electronic device 102 may send the current frame 126 to the remote device 104 via a wired or wireless link. In the case of wireless display mirroring, the electronic device 102 may send the current frame 126 to the remote device 104 using an IEEE 802.11 wireless link. Because the current frame 126 is generated by the electronic device 102, the display mirroring is not dependent on the hardware of the remote device 104 to generate the image displayed on the mirrored display 134. Therefore, the described systems and methods do not rely on new specifications or interfaces with the remote device 104 to perform display mirroring. In other words, the remote device 104 is unaware of how the current frame 126 is generated.

The described systems and methods provide the following benefits. Because the GPU 114 is not used to compose to the frame buffer 116, resources are saved that would be used for one full frame buffer 116 write in the first format 112 (e.g., ARGB). The GPU cycles that are preserved may be used for rendering of application buffers, which may lead to a lower system clock. Furthermore, the MDP 118 need not read one full frame buffer 116 in the first format 112. This may save power and improve bus bandwidth. Also, this may result in smoother transitions between frames, which may reduce lag and improve the user experience.

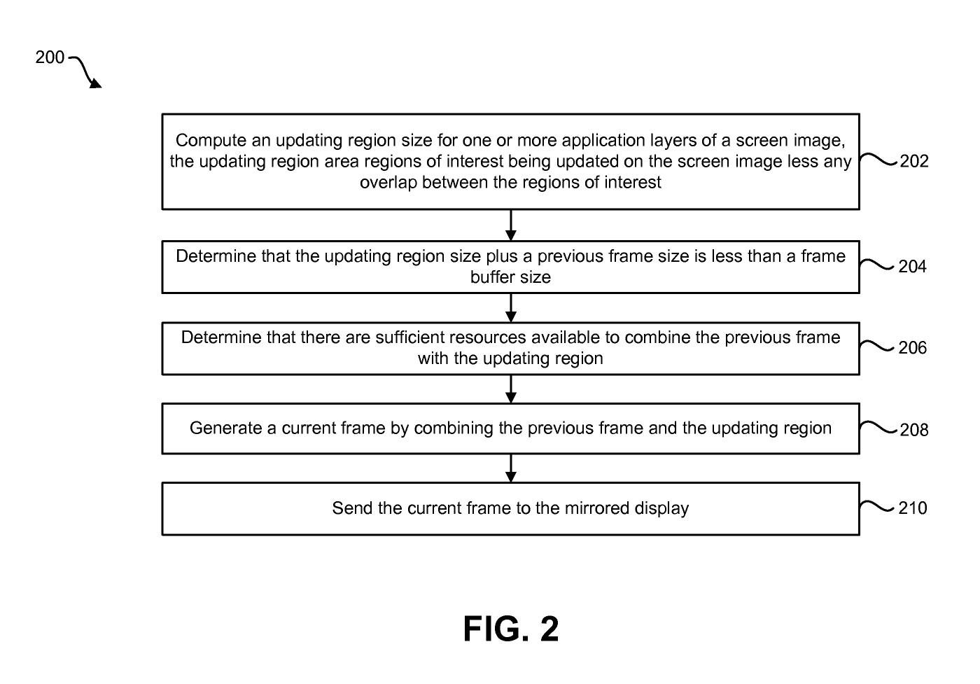

FIG. 2 is a flow diagram illustrating a method 200 for performing display mirroring. The method 200 may be performed by an electronic device 102. The electronic device 102 may be in communication with a remote device 104 that includes a mirrored display 134.

The electronic device 102 may compute 202 the size of an updating region 110 for one or more application layers 108 of a screen image 106. The updating region 110 may be the combined area of a set of regions of interest (ROI) 129 that are being updated on the screen image 106 less any overlap between the ROI 129. Therefore, the size of the updating region 110 may be the summation of the size of each ROI 129 while accounting for any overlap (e.g., union) between the ROIs 129.

The updating region 110 (and the ROIs 129) may be provided in a first format 112. For example, the updating region 110 may be provided in an ARGB format. The size of the updating region 110 may be determined based on the first format 112.

The electronic device 102 may determine 204 that the updating region 110 size plus the size of the previous frame 120 is less than the frame buffer 116 size. For example, the electronic device 102 may save the previous frame 120 that was displayed. The previous frame 120 may be in a second format 122. For example, the previous frame 120 may be in the NV12 format.

The frame buffer 116 size may be a known quantity. The frame buffer 116 size may be based on the display 128 resolution and the first format 112. Because the previous frame 120 is in the second format 122, the previous frame 120 may have a smaller size than the size of the frame buffer 116, which is in the first format 112 (e.g., ARGB format).

The electronic device 102 may determine 206 that there are sufficient resources available to combine the previous frame 120 with the updating region 110. The resources may be two or more different hardware resources used to blend the previous frame 120 with the updating region 110. In one implementation, these resources may be included in an MDP 118. For example, the resources may be a blending engine included in the MDP 118.

The electronic device 102 may generate 208 the current frame 126 by combining the previous frame 120 and the updating region 110. For example, the previous frame 120 and the updating region 110 may be fed into the MDP 118 hardware (e.g., blending engine) and combined. In other words, the previously composed (N−1th) frame 120 and the updating region 110 from the current (Nth) frame may be fed into the MDP 118 hardware to compose the current (Nth) frame 126.

The electronic device 102 may combine the ROI 129 of the updating region 110 as indicated by their coordinates. The ROI 129 may be positioned on top of the previous frame 120 according to the coordinates of the ROI 129. Therefore, instead of composing all application layers 108, the current frame 126 may be generated from the previous frame 120 and the updating region 110.

The electronic device 102 may send 210 the current frame 126 to the mirrored display 134. For example, the electronic device 102 may send 210 the current frame 126 to the remote device 104 via a wired or wireless link. In the case of wireless display mirroring, the electronic device 102 may send 210 the current frame 126 to the remote device 104 using an IEEE 802.11 wireless link. The remote device 104 may process the current frame 126 for display by the mirrored display 134.

FIG. 3 is a block diagram illustrating an example of a screen image 306 according to the described systems and methods. The screen image 306 includes three application layers 308. A clock application layer 308a is associated with a clock application. A network status application layer 308b is associated with a network status application. A messenger application layer 308c is associated with a messenger application.

In this example, there are three regions or interest (ROIs) 329. A first ROI 329a is associated with the changing time of the clock application layer 308a. A second ROI 329b is associated with a change in the network status application layer 308b. A third ROI 329c is associated with a change in the “To” field of the messenger application layer 308c.

As described above, the ROIs 329 may include coordinates and an area. The ROIs 329 may be combined to form the updating region 110, as described in connection with FIG. 1.

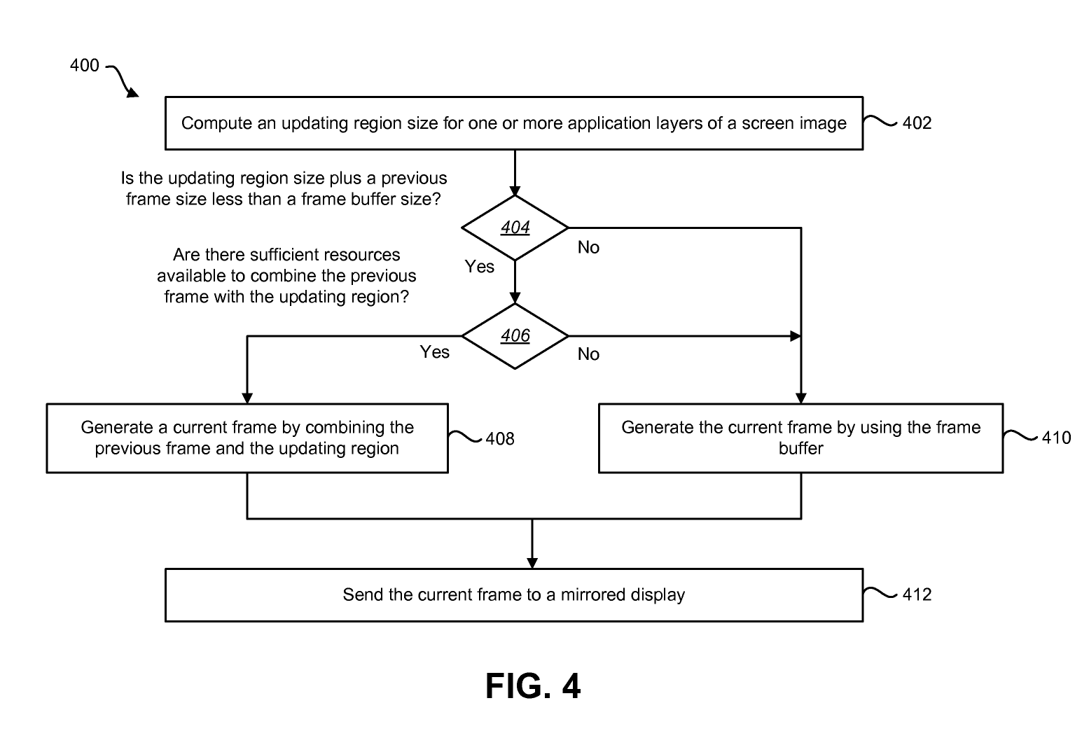

FIG. 4 is a flow diagram illustrating another method 400 for performing display mirroring. The method 400 may be performed by an electronic device 102. The electronic device 102 may be in communication with a remote device 104 that includes a mirrored display 134.

The electronic device 102 may compute 402 the size of an updating region 110 for one or more application layers 108 of a screen image 106. This may be accomplished as described in connection with FIG. 2.

The electronic device 102 may determine 404 whether the updating region 110 size plus a previous frame 120 size is less than the frame buffer 116 size. The electronic device 102 may save the previous frame 120 that was displayed. The previous frame 120 may be in a second format 122. For example, the previous frame 120 may be in an NV12 format.

The frame buffer 116 size may be a known quantity. The frame buffer 116 size may be based on the display 128 resolution and the first format 112. Because the previous frame 120 is in the second format 122, the previous frame 120 may have a smaller size than the size of the frame buffer 116, which is in the first format 112 (e.g., ARGB format).

If the electronic device 102 determines 404 that the updating region 110 size plus a previous frame 120 size is less than the frame buffer 116 size, then the electronic device 102 may determine 406 whether there are sufficient resources available to combine the previous frame 120 with the updating region 110. The resources may be two or more different hardware resources used to blend the previous frame 120 with the updating region 110. In one implementation, these resources may be included in an MDP 118. For example, the resources may be a blending engine included in the MDP 118.

If the electronic device 102 determines 406 that there are sufficient resources available to combine the previous frame 120 with the updating region 110, then the electronic device 102 may generate 408 the current frame 126 by combining the previous frame 120 and the updating region 110. For example, the previous frame 120 and the updating region 110 may be fed into the MDP 118 hardware (e.g., blending engine) and combined.

The electronic device 102 may combine the ROI 129 of the updating region 110 as indicated by their coordinates. The ROI 129 may be positioned on top of the previous frame 120 according to the coordinates of the ROI 129. Therefore, instead of composing all application layers 108, the current frame 126 may be generated from the previous frame 120 and the updating region 110.

If the electronic device 102 determines 404 that the updating region 110 size plus the previous frame 120 size is not less than a frame buffer 116 size, then the electronic device 102 may generate 410 the current frame 126 from the frame buffer 116, as described in connection with FIG. 1. For example, a GPU 114 may compose the entire screen image 106 to the frame buffer 116. The frame buffer 116 may then be provided to the MDP 118 to generate the current frame 126.

Similarly, if the electronic device 102 determines 406 that there are not sufficient resources to combine the previous frame 120 with the updating region 110, then the current frame 126 may be generated from the frame buffer 116.

The electronic device 102 may send 412 the current frame 126 to the mirrored display 134. For example, the electronic device 102 may send 412 the current frame 126 to the remote device 104 via a wired or wireless link. In the case of wireless display mirroring, the electronic device 102 may send 412 the current frame 126 to the remote device 104 using an IEEE 802.11 wireless link.

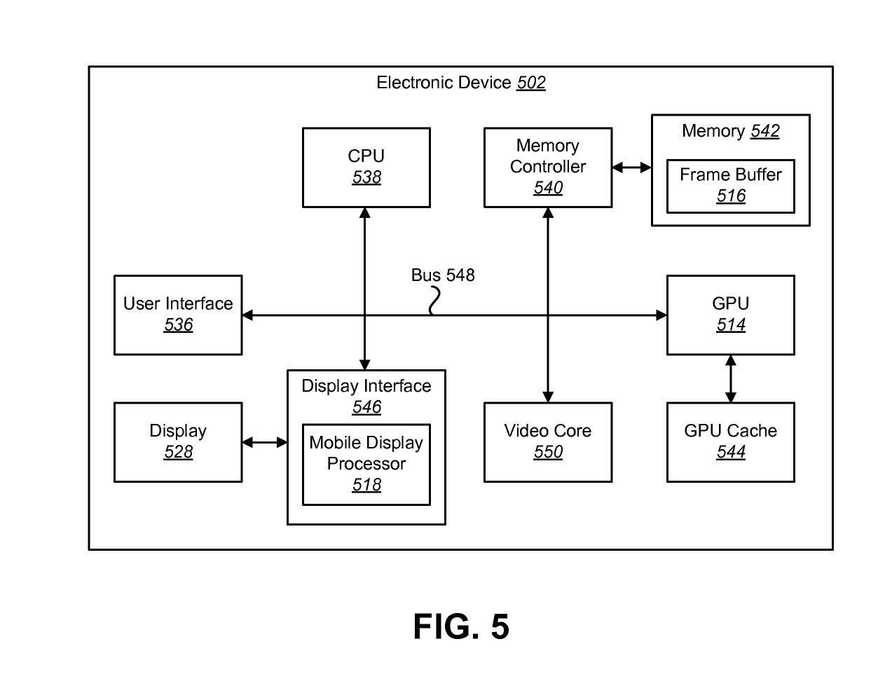

FIG. 5 is a block diagram illustrating an example electronic device 502 that may be used to implement the techniques described in this disclosure. Electronic device 502 may comprise a personal computer, a desktop computer, a laptop computer, a computer workstation, a video game platform or console, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA), a personal music player, a video player, a display device, a television, a television set-top box, a server, an intermediate network device, a mainframe computer or any other type of device that processes and/or displays graphical data.

As illustrated in the example of FIG. 5, the electronic device 502 includes a user interface 536, a CPU 538, a memory controller 540, a system memory 542, a GPU 514, a GPU cache 544, a display interface 546, a display 528, a bus 548, and a video core 550. As further illustrated in the example of FIG. 5, the video core 550 may be a separate functional block. In other examples, the video core 550 may be part of the GPU 514, the display interface 546, or some other functional block illustrated in FIG. 5.

The user interface 536, CPU 538, memory controller 540, GPU 514 and display interface 546 may communicate with each other using the bus 548. It should be noted that the specific configuration of buses and communication interfaces between the different components illustrated in FIG. 5 is merely exemplary, and other configurations of electronic devices and/or other graphics processing systems with the same or different components may be used to implement the techniques of this disclosure.

The CPU 538 may comprise a general-purpose or a special-purpose processor that controls operation of electronic device 502. A user may provide input to the electronic device 502 to cause the CPU 538 to execute one or more software applications. The software applications that execute on the CPU 538 may include, for example, an operating system 127, a word processor application, an email application, a spreadsheet application, a media player application, a video game application, a graphical user interface application or another program. The user may provide input to electronic device 502 via one or more input devices (not shown) such as a keyboard, a mouse, a microphone, a touch pad, a touch screen or another input device that is coupled to electronic device 502 via the user interface 536.

The software applications that execute on the CPU 538 may include one or more graphics rendering instructions that instruct the GPU 514 to cause the rendering of graphics data to display 528. In some examples, the software instructions may conform to a graphics application programming interface (API), such as, e.g., an Open Graphics Library (OpenGL®) API, an Open Graphics Library Embedded Systems (OpenGL ES) API, a Direct3D API, a DirectX API, a RenderMan API, a WebGL API, or any other public or proprietary standard graphics API. In order to process the graphics rendering instructions, the CPU 538 may issue one or more graphics rendering commands to the GPU 514 to cause the GPU 514 to perform some or all of the rendering of the graphics data. In some examples, the graphics data to be rendered may include a list of graphics primitives, e.g., points, lines, triangles, quadralaterals, triangle strips, patches, etc.

The memory controller 540 facilitates the transfer of data going into and out of system memory 542. For example, memory controller 540 may receive memory read requests and memory write requests from the CPU 538 and/or the GPU 514, and service such requests with respect to the system memory 542 in order to provide memory services for the components in the electronic device 502. The memory controller 540 is communicatively coupled to system memory 542. Although the memory controller 540 is illustrated in the example electronic device 502 of FIG. 5 as being a processing module that is separate from both CPU 538 and system memory 542, in other examples, some or all of the functionality of the memory controller 540 may be implemented on one or more of the CPU 538, the GPU 514, and the system memory 542.

The system memory 542 may store program modules and/or instructions that are accessible for execution by the CPU 538 and/or data for use by the programs executing on the CPU 538. For example, the system memory 542 may store user applications and graphics data associated with the applications. The system memory 542 may also store information for use by and/or generated by other components of the electronic device 502. The system memory 542 may act as a device memory for the GPU 514 and may store data to be operated on by the GPU 514 as well as data resulting from operations performed by the GPU 514. For example, the system memory 542 may store any combination of path data, path segment data, surfaces, texture buffers, depth buffers, cell buffers, vertex buffers, frame buffers 516, or the like. In addition, the system memory 542 may store command streams for processing by the GPU 514. The system memory 542 may include one or more volatile or non-volatile memories or storage devices, such as, for example, random access memory (RAM), static RAM (SRAM), dynamic RAM (DRAM), synchronous dynamic random access memory (SDRAM), read-only memory (ROM), erasable programmable ROM (EPROM), electrically erasable programmable ROM (EEPROM), Flash memory, a magnetic data media or an optical storage media.

The GPU 514 may be configured to execute commands that are issued to the GPU 514 by the CPU 538. The commands executed by the GPU 514 may include graphics commands, draw call commands, GPU state programming commands, memory transfer commands, general-purpose computing commands, kernel execution commands, etc. The memory transfer commands may include, e.g., memory copy commands, memory compositing commands, and block transfer (blitting) commands.

In some examples, the GPU 514 may be configured to perform graphics operations to render one or more graphics primitives to the display 528. In such examples, when one of the software applications executing on the CPU 538 requires graphics processing, CPU 538 may provide graphics data to the GPU 514 for rendering to the display 528 and issue one or more graphics commands to the GPU 514.

The graphics commands may include, e.g., draw call commands, GPU state programming commands, memory transfer commands, blitting commands, etc. The graphics data may include vertex buffers, texture data, surface data, etc. In some examples, the CPU 538 may provide the commands and graphics data to the GPU 514 by writing the commands and graphics data to system memory 542, which may be accessed by the GPU 514.

In further examples, the GPU 514 may be configured to perform general-purpose computing for applications executing on the CPU 538. In such examples, when one of the software applications executing on the CPU 538 decides to off-load a computational task to the GPU 514, CPU 538 may provide general-purpose computing data to the GPU 514, and issue one or more general-purpose computing commands to the GPU 514. The general-purpose computing commands may include, e.g., kernel execution commands, memory transfer commands, etc. In some examples, the CPU 538 may provide the commands and general-purpose computing data to the GPU 514 by writing the commands and graphics data to the system memory 542, which may be accessed by the GPU 514.

The GPU 514 may, in some instances, be built with a highly-parallel structure that provides more efficient processing than the CPU 538. For example, the GPU 514 may include a plurality of processing elements that are configured to operate on multiple vertices, control points, pixels and/or other data in a parallel manner. The highly parallel nature of the GPU 514 may, in some instances, allow the GPU 514 to render graphics images (e.g., GUIs and two-dimensional (2D) and/or three-dimensional (3D) graphics scenes) onto display 528 more quickly than rendering the images using the CPU 538. In addition, the highly parallel nature of the GPU 514 may allow the GPU 514 to process certain types of vector and matrix operations for general-purposed computing applications more quickly than the CPU 538.

The GPU 514 may, in some examples, be integrated into a motherboard of electronic device 502. In other instances, the GPU 514 may be present on a graphics card that is installed in a port in the motherboard of electronic device 502 or may be otherwise incorporated within a peripheral device configured to interoperate with electronic device 502. In further instances, the GPU 514 may be located on the same microchip as the CPU 538 forming a system on a chip (SoC). The GPU 514 may include one or more processors, such as one or more microprocessors, application specific integrated circuits (ASICs), field programmable gate arrays (FPGAs), digital signal processors (DSPs), or other equivalent integrated or discrete logic circuitry.

In some examples, the GPU 514 may be directly coupled to the GPU cache 544. Thus, the GPU 514 may read data from and write data to the GPU cache 544 without necessarily using the bus 548. In other words, the GPU 514 may process data locally using a local storage, instead of off-chip memory. This allows the GPU 514 to operate in a more efficient manner by eliminating the need of the GPU 514 to read and write data via the bus 548, which may experience heavy bus traffic. In some instances, however, the GPU 514 may not include a separate cache, but instead utilize system memory 542 via the bus 548. The GPU cache 544 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media, or an optical storage media.

The GPU 514 may compose a screen image 106 to the frame buffer 516. This may be accomplished as described in connection with FIG. 1. The CPU 538, GPU 514, or both may store rendered image data in a frame buffer 516 that is allocated within system memory 542.

The display interface 546 may retrieve the data from the frame buffer 516 and configure the display 528 to display the image represented by the rendered image data. The display interface 546 may include a mobile display processor (MDP) 518. The MDP 518 of FIG. 5 may be implemented in accordance to the MDP 118 described in connection with FIG. 1. The MDP 518 may generate a current frame 126 for display on the display 528. In one implementation, the current frame 126 may be generated from a previous frame 120 and the updating region 110 of the screen image 106.

In some examples, the display interface 546 may include a digital-to-analog converter (DAC) that is configured to convert the digital values retrieved from the frame buffer 516 into an analog signal consumable by display 528. In other examples, the display interface 546 may pass the digital values directly to the display 528 for processing.

The display 528 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. The display 528 may be integrated within electronic device 502. For instance, display 528 may be a screen of a mobile handset or a tablet computer. Alternatively, display 528 may be a stand-alone device coupled to the electronic device 502 via a wired or wireless communications link. For instance, the display 528 may be a computer monitor or flat panel display connected to a personal computer via a cable or wireless link. In yet another implementation, the electronic device 502 may provide image data (e.g., a current frame 126) to a mirrored display 134 on a remote device 104.

The bus 548 may be implemented using any combination of bus structures and bus protocols including first, second and third generation bus structures and protocols, shared bus structures and protocols, point-to-point bus structures and protocols, unidirectional bus structures and protocols, and bidirectional bus structures and protocols. Examples of different bus structures and protocols that may be used to implement the bus 548 include, e.g., a HyperTransport bus, an InfiniBand bus, an Advanced Graphics Port bus, a Peripheral Component Interconnect (PCI) bus, a PCI Express bus, an Advanced Microcontroller Bus Architecture (AMBA) Advanced High-performance Bus (AHB), an AMBA Advanced Peripheral Bus (APB), and an AMBA Advanced eXentisible Interface (AXI) bus. Other types of bus structures and protocols may also be used.

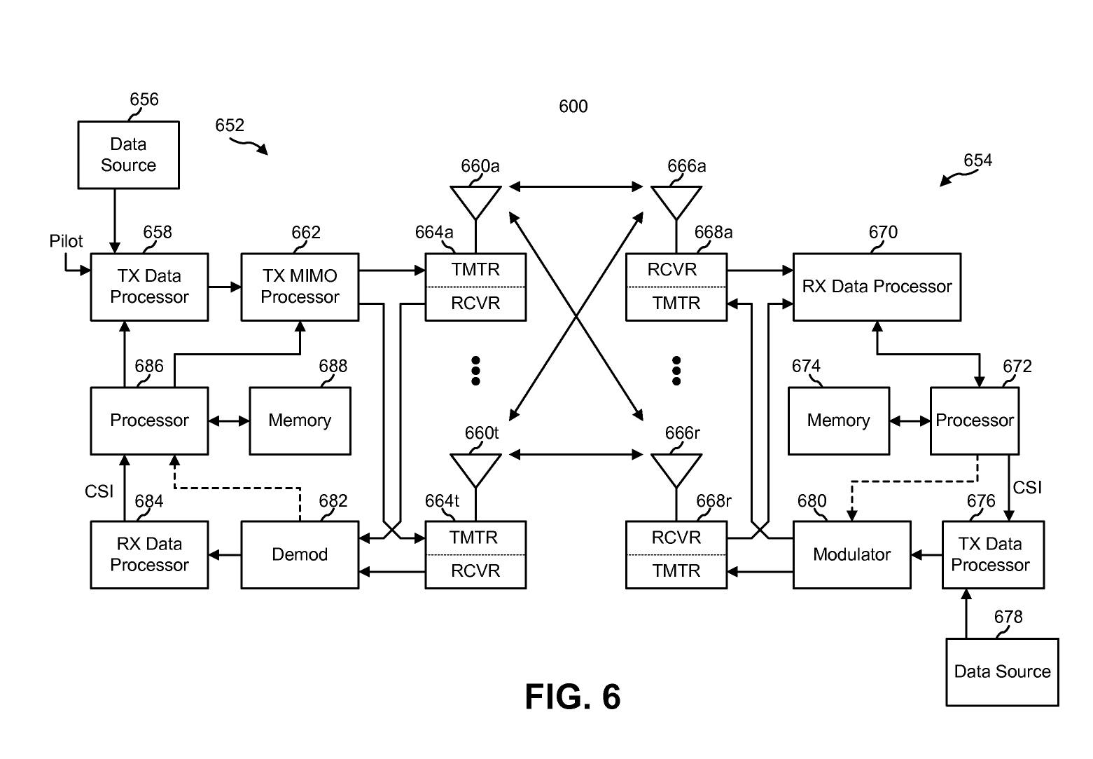

FIG. 6 is a block diagram of a transmitter 652 and receiver 654 in a multiple-input and multiple-output (MIMO) system 600. Examples of transmitters 652 may include electronic devices 102 and 502 and remote device 104. Additionally or alternatively, examples of receivers 654 may include electronic devices 102 and 502 and remote devices 104. In the transmitter 652, traffic data for a number of data streams is provided from a data source 656 to a transmit (TX) data processor 658. Each data stream may then be transmitted over a respective transmit antenna 660a-t. The transmit (TX) data processor 658 may format, code, and interleave the traffic data for each data stream based on a particular coding scheme selected for that data stream to provide coded data.

The coded data for each data stream may be multiplexed with pilot data (e.g., reference signals) using orthogonal frequency-division multiplexing (OFDM) techniques. The pilot data may be a known data pattern that is processed in a known manner and used at the receiver 654 to estimate the channel response. The multiplexed pilot and coded data for each stream is then modulated (i.e., symbol mapped) based on a particular modulation scheme (e.g., binary phase shift keying (BPSK), quadrature phase shift keying (QPSK), multiple phase shift keying (M-PSK) or multi-level quadrature amplitude modulation (M-QAM)) selected for that data stream to provide modulation symbols. The data rate, coding and modulation for each data stream may be determined by instructions performed by a processor.

The modulation symbols for all data streams may be provided to a transmit (TX) multiple-input multiple-output (MIMO) processor 662, which may further process the modulation symbols (e.g., for OFDM). The transmit (TX) multiple-input multiple-output (MIMO) processor 662 then provides NT modulation symbol streams to NT transmitters (TMTR) 664a through 664t. The TX transmit (TX) multiple-input multiple-output (MIMO) processor 662 may apply beamforming weights to the symbols of the data streams and to the antenna 660 from which the symbol is being transmitted.

Each transmitter 664 may receive and process a respective symbol stream to provide one or more analog signals, and further condition (e.g., amplify, filter, and upconvert) the analog signals to provide a modulated signal suitable for transmission over the MIMO channel. NT modulated signals from transmitters 664a through 664t are then transmitted from NT antennas 660a through 660t, respectively.

At the receiver 654, the transmitted modulated signals are received by NR antennas 666a through 666r and the received signal from each antenna 666 is provided to a respective receiver (RCVR) 668a through 668r. Each receiver 668 may condition (e.g., filter, amplify, and downconvert) a respective received signal, digitize the conditioned signal to provide samples, and further process the samples to provide a corresponding “received” symbol stream.

An RX data processor 670 then receives and processes the NR received symbol streams from NR receivers 668 based on a particular receiver processing technique to provide NT “detected” symbol streams. The RX data processor 670 then demodulates, deinterleaves and decodes each detected symbol stream to recover the traffic data for the data stream. The processing by RX data processor 670 may be complementary to that performed by TX MIMO processor 662 and TX data processor 658 at the transmitter 652.

A processor 672 may periodically determine which pre-coding matrix to use. The processor 672 may store information on and retrieve information from memory 674. The processor 672 formulates a reverse link message comprising a matrix index portion and a rank value portion. The reverse link message may be referred to as channel state information (CSI). The reverse link message may comprise various types of information regarding the communication link and/or the received data stream. The reverse link message is then processed by a TX data processor 676, which also receives traffic data for a number of data streams from a data source 678, modulated by a modulator 680, conditioned by transmitters 668a through 668r, and transmitted back to the transmitter 652.

At the transmitter 652, the modulated signals from the receiver are received by antennas 660, conditioned by receivers 664, demodulated by a demodulator 682 and processed by an RX data processor 684 to extract the reverse link message transmitted by the receiver 654 system. A processor 686 may receive channel state information (CSI) from the RX data processor 684. The processor 686 may store information on and retrieve information from memory 688. The processor 686 then determines which pre-coding matrix to use for determining the beamforming weights and then processes the extracted message. The one or more electronic devices 102 and 502 discussed above may be configured similarly to the transmitter 652 illustrated in FIG. 6 in some configurations. The one or more remote devices 104 discussed above may be configured similarly to the receiver 654 illustrated in FIG. 6 in some configurations.

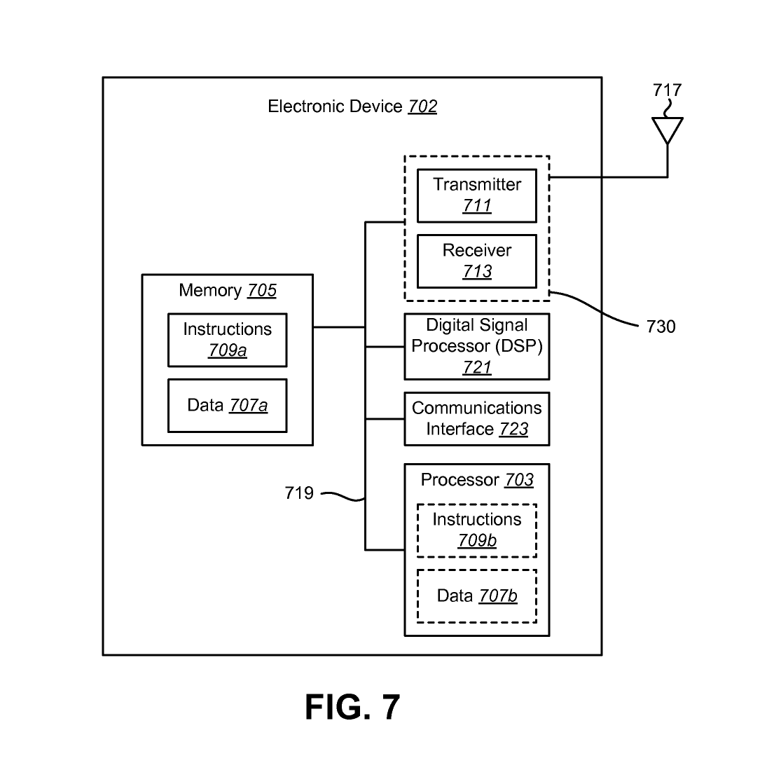

FIG. 7 illustrates certain components that may be included within an electronic device 702. The electronic device 702 may be a wireless device, an access terminal, a mobile station, a user equipment (UE), a laptop computer, a desktop computer, etc. For example, the electronic device 702 of FIG. 7 may be implemented in accordance with the electronic device 102 of FIG. 1.

The electronic device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the electronic device 702 of FIG. 7, in an alternative configuration, a combination of processors (e.g., an ARM and DSP) could be used.

The electronic device 702 also includes memory 705 in electronic communication with the processor 703 (i.e., the processor can read information from and/or write information to the memory). The memory 705 may be any electronic component capable of storing electronic information. The memory 705 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 707a and instructions 709a may be stored in the memory 705. The instructions 709a may include one or more programs, routines, sub-routines, functions, procedures, code, etc. The instructions 709a may include a single computer-readable statement or many computer-readable statements. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The electronic device 702 may also include a transmitter 711 and a receiver 713 to allow transmission and reception of signals to and from the electronic device 702 via an antenna 717. The transmitter 711 and receiver 713 may be collectively referred to as a transceiver 730. The electronic device 702 may also include (not shown) multiple transmitters, multiple antennas, multiple receivers and/or multiple transceivers.

The electronic device 702 may include a digital signal processor (DSP) 721. The electronic device 702 may also include a communications interface 723. The communications interface 723 may allow a user to interact with the electronic device 702.

The various components of the electronic device 702 may be coupled together by one or more buses, which may include a power bus, a control signal bus, a status signal bus, a data bus, etc. For the sake of clarity, the various buses are illustrated in FIG. 7 as a bus system 719.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as illustrated by FIG. 2 and FIG. 4, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for display mirroring, comprising:
computing an updating region size for one or more application layers of a screen image, the updating region area regions of interest being updated on the screen image less any overlap between the regions of interest;
determining that the updating region size plus a previous frame size is less than a frame buffer size;
determining that there are sufficient resources available to combine the previous frame with the updating region;
generating a current frame by combining the previous frame and the updating region; and
sending the current frame to a mirrored display.

2. The method of claim 1, wherein the current frame is sent to the mirrored display using an IEEE 802.11 wireless link.

3. The method of claim 1, wherein the current frame is sent to the mirrored display using a universal serial bus (USB) connection or a high-definition multimedia interface (HDMI) connection.

4. The method of claim 1, wherein the frame buffer has a first format and the previous frame has a second format.

5. The method of claim 4, wherein the previous frame is converted from the first format to the second format.

6. The method of claim 4, wherein the first format is an Alpha Red Green Blue (ARGB) format and the second format is an NV12 format.

7. The method of claim 1, wherein determining that there are sufficient resources available to combine the previous frame with the updating region comprises determining that a mobile display processor has sufficient hardware resources to blend the previous frame and the updating region.

8. The method of claim 1, wherein the determining steps are performed by a software driver of a mobile display processor.

9. An electronic device configured for display mirroring, comprising:
a processor;
a memory in communication with the processor; and
instructions stored in the memory, the instructions executable by the processor to:
compute an updating region size for one or more application layers of a screen image, the updating region area regions of interest being updated on the screen image less any overlap between the regions of interest;
determine that the updating region size plus a previous frame size is less than a frame buffer size;
determine that there are sufficient resources available to combine the previous frame with the updating region;
generate a current frame by combining the previous frame and the updating region; and
send the current frame to a mirrored display.

10. The electronic device of claim 9, wherein the current frame is sent to the mirrored display using an IEEE 802.11 wireless link.

11. The electronic device of claim 9, wherein the current frame is sent to the mirrored display using a universal serial bus (USB) connection or a high-definition multimedia interface (HDMI) connection.

12. The electronic device of claim 9, wherein the frame buffer has a first format and the previous frame has a second format.

13. The electronic device of claim 12, wherein the previous frame is converted from the first format to the second format.

14. The electronic device of claim 12, wherein the first format is an Alpha Red Green Blue (ARGB) format and the second format is an NV12 format.

15. The electronic device of claim 9, wherein the instructions executable to determine that there are sufficient resources available to combine the previous frame with the updating region comprise instructions executable to determine that a mobile display processor has sufficient hardware resources to blend the previous frame and the updating region.

16. The electronic device of claim 9, wherein the determining steps are performed by a software driver of a mobile display processor.

17. An apparatus for display mirroring, comprising:
means for computing an updating region size for one or more application layers of a screen image, the updating region area regions of interest being updated on the screen image less any overlap between the regions of interest;
means for determining that the updating region size plus a previous frame size is less than a frame buffer size;
means for determining that there are sufficient resources available to combine the previous frame with the updating region;
means for generating a current frame by combining the previous frame and the updating region; and
means for sending the current frame to a mirrored display.

18. The apparatus of claim 17, wherein the current frame is sent to the mirrored display using an IEEE 802.11 wireless link.

19. The apparatus of claim 17, wherein the current frame is sent to the mirrored display using a universal serial bus (USB) connection or a high-definition multimedia interface (HDMI) connection.

20. The apparatus of claim 17, wherein the frame buffer has a first format and the previous frame has a second format.

21. The apparatus of claim 20, wherein the previous frame is converted from the first format to the second format.

22. The apparatus of claim 20, wherein the first format is an Alpha Red Green Blue (ARGB) format and the second format is an NV12 format.

23. The apparatus of claim 17, wherein the means for determining that there are sufficient resources available to combine the previous frame with the updating region comprise means for determining that a mobile display processor has sufficient hardware resources to blend the previous frame and the updating region.

24. A computer-program product for display mirroring, comprising a non-transitory computer-readable medium having instructions thereon, the instructions comprising:
code for causing an electronic device to compute an updating region size for one or more application layers of a screen image, the updating region area regions of interest being updated on the screen image less any overlap between the regions of interest;
code for causing the electronic device to determine that the updating region size plus a previous frame size is less than a frame buffer size;
code for causing the electronic device to determine that there are sufficient resources available to combine the previous frame with the updating region;
code for causing the electronic device to generate a current frame by combining the previous frame and the updating region; and
code for causing the electronic device to send the current frame to a mirrored display.

25. The computer-program product of claim 24, wherein the current frame is sent to the mirrored display using an IEEE 802.11 wireless link.

26. The computer-program product of claim 24, wherein the current frame is sent to the mirrored display using a universal serial bus (USB) connection or a high-definition multimedia interface (HDMI) connection.

27. The computer-program product of claim 24, wherein the frame buffer has a first format and the previous frame has a second format.

28. The computer-program product of claim 27, wherein the previous frame is converted from the first format to the second format.

29. The computer-program product of claim 27, wherein the first format is an Alpha Red Green Blue (ARGB) format and the second format is an NV12 format.

30. The computer-program product of claim 24, wherein the code for causing the electronic device to determine that there are sufficient resources available to combine the previous frame with the updating region comprises code for causing the electronic device to determine that a mobile display processor has sufficient hardware resources to blend the previous frame and the updating region.
